(19) United States
(12) Patent Application Publication
(10) Pub. No.: US 2026/0263969 A1
(43) Pub. Date: Sep. 10, 2026

(54) APPARATUS AND METHOD FOR SEPARATING AND CONCENTRATING A COMPONENT OF A FLUID

(71) Applicant: Biomet Biologics, LLC, Warsaw, IN (US)

(72) Inventor: Kyle Kausch, Warsaw, IN (US)

(21) Appl. No.: 19/556,894

(22) Filed: Mar. 4, 2026

Related U.S. Application Data
(60) Provisional application No. 63/767,288, filed on Mar. 5, 2025.

(51) Int. Cl. B01D 21/26

(52) U.S. Cl. CPC B01D 21/262; B01D 2221/10

(57) ABSTRACT

A device may include a separation container forming a first portion of the device and a concentration container forming a second portion of the device. A device may include a buoy system positioned within a first chamber of the separation container. The buoy system configured to assist in a separation of the whole material. A device may include a first port assembly and a second port assembly in fluid communication with the first chamber. A device may include a third port assembly in fluid communication with the concentration container. A device may include a vent assembly including a pathway configured to a provide a flow of air between the first chamber and a second chamber of the concentration container.

### CLAIM OF PRIORITY

This application claims the benefit of U.S. Provisional Patent Application Serial No. 63/767,288, filed on March 5, 2025, the benefit of priority of which is claimed hereby, and which is incorporated by reference herein in its entirety.

### FIELD

This patent document generally pertains to a method, system and apparatus for separating and concentrating a material and more particularly, but not by way of limitation, to the separation of a whole material such into at least two fractions and concentrating at least one of the fractions in a single container.

### BACKGROUND

This section provides background information related to the present disclosure, but such background information is not admitted as being prior art.

Although joint replacement is the gold standard treatment for advanced osteoarthritis (OA), other therapeutic methods focus on joint preservation and cartilage repair in OA subjects. Current and emergent regenerative strategies include targeting the affected joint environment with biological modifiers, such as differentiated or undifferentiated progenitor or stem cells and growth factors. Cellular regenerative therapies for OA include the use of chondrocytes or multipotential mesenchymal stromal cells (also known as marrow stromal cells, mesenchymal stem cells, mesenchymal stromal cells, or multipotential mesenchymal stem cells). Chondrocyte-based therapy is popular; however, it has some limitations and requires multiple operations and in vitro manipulation. Multipotential mesenchymal stromal cells have emerged as an alternative to chondrocyte regenerative therapy because multipotential stromal cells are derived from tissue that is abundant and these cells have a higher proliferative capability. Multipotential mesenchymal stromal cells can be derived from bone marrow, bone marrow aspirate, blood and blood fractions (e.g., blood-based autologous protein solutions), bone marrow fractions e.g., bone marrow-based autologous protein solution (multipotential mesenchymal stromal cells derived from these sources).

Whole materials can be formed of multiple components that can form fractions. For example, whole blood, or other biological materials, can include various components that make up the whole. The various components of the whole material may be separated via gravity separation due to the varying densities of the components. Generally, centrifugation can be used to gravity separate different components of a whole material into fractions.

A centrifuge tube can be placed in a centrifuge after being filled with a selected whole material. The tube including the selected whole material can then be centrifuged at a selected speed and time for gravity separation of the whole material. The component of the whole material that is separated, however, remains at the original concentration of the selected. Accordingly, gravity separating does not generally concentrate any selected component.

Various separation systems have been developed but are not ideal for various reasons including from an operation or manufacturing cost and/or complexity standpoint.

### OVERVIEW

This overview is intended to provide an overview of subject matter of the present patent application. It is not intended to provide an exclusive or exhaustive explanation of the present technology, the invention or its full scope or all its features. The detailed description is included to provide further information about the present technology.

The present application describes a device with an integrated container system that is an assembly of a separation container and a concentration container. The present device addresses operational and/or manufacturing inconveniences with prior separation and concentration systems. Thus, the device includes a separation container portion and a concentration container portion combined into an all-in-one system that improves upon prior two-part systems such as nStride® Autologous Protein Solution Kit from Zimmer Biomet, which include multiple components that must be manufactured and processed separately.

The container incorporates an improved venting system that provides direct air communication between a first chamber in the separation container and a second chamber in the concentration container through a dedicated pathway. This dedicated pathway can bypassing an intermediate third chamber. This venting configuration eliminates the need for sidewall venting and/or the use of a complex check valve assembly that created manufacturing challenges with prior separation and concentration systems. The venting system configuration can utilize a filter with a desired pore size to capture and exclude cells. Thus, the venting system is configured to maintain proper air exchange during fluid transfer into and out of the device while preventing contamination.

Additionally, the container can have four port assemblies that facilitate efficient processing of a fluid such as blood and components thereof without the need for a check valve assembly. The first port enables initial fluid (e.g., whole blood) filling and removal of a first separated component (e.g., platelet-poor plasma (PPP)), while the second port allows for removal of a second separated component (e.g., platelet-rich plasma (PRP)). The third port can accommodate loading of the second component (e.g., the PRP) and/or another suitable material into the concentration container (e.g., the second chamber), and the fourth port can enable removal of the final concentrated product from the concentration container at yet the third chamber. This configuration with four ports eliminates the need for the check valve assembly such as disclosed in United States Patent No. 9,808,568B2 (the ‘568 patent), the entire specification of which is incorporated herein in its entirety, while maintaining full functionality for separation and concentration in a single device. Additionally, the new venting pathway of the present application is provided within the device between the separation and concentration containers, which eliminates the need for inconvenient side and lid venting used with the ‘568 patent.

Thus, the device of the present application enables a complete process of separating a biological material such as whole blood into fractions, isolating and concentrating platelet rich plasma, and producing a final concentrated therapeutic product in a single container system with improved air handling characteristics.

To further illustrate the methods, apparatuses and systems disclosed herein, a non-limiting list of aspects of the invention provided here:

Example 1 is a device to separate and concentrate a component of a whole material, optionally comprising: a separation container forming a first portion of the device and a concentration container forming a second portion of the device; a buoy system positioned within a first chamber of the separation container, wherein the buoy system configured to assist in a separation of the whole material; a first port assembly and a second port assembly in fluid communication with the first chamber; a third port assembly in fluid communication with the concentration container; and a vent assembly including a pathway configured to a provide a flow of air between the first chamber and a second chamber of the concentration container.

In Example 2, the subject matter of Example 1 optionally includes, a fourth port assembly in fluid communication with a third chamber of the concentration container.

In Example 3, the subject matter of Example 2 optionally includes, wherein the first port assembly and the third port assembly each include a vented cap and the second port assembly and the fourth port assembly each include a non-vented cap.

In Example 4, the subject matter of Examples 2–3 optionally includes, a filter positioned between and separating the third chamber from the second chamber and configured to support a desiccant placed within the second chamber adjacent the filter.

In Example 5, the subject matter of Examples 1–4 optionally includes, wherein the vent assembly includes a filter configured to capture cells but permit the flow of air therethrough.

In Example 6, the subject matter of Example 5 optionally includes, wherein the filter is positioned in the second chamber at an opening to the pathway, wherein the opening is proud of a bottom surface of the second chamber.

In Example 7, the subject matter of Examples 5–6 optionally includes, wherein the filter is formed of polymeric material having a plurality of pores therethrough.

In Example 8, the subject matter of Example 7 optionally includes, wherein the plurality of pores are between approximately 1.5 microns and 4.5 microns in diameter.

In Example 9, the subject matter of Examples 5–8 optionally includes, wherein the vent assembly including the pathway bypasses and is not in direct fluid communication with a third chamber of the concentration container.

Example 10 is a device to separate and concentrate a component of a whole material, optionally comprising: a separation container forming a first portion of the device and a concentration container forming a second portion of the device; a buoy system positioned within a first chamber of the separation container, wherein the buoy system configured to assist in a separation of the whole material; a first port assembly and a second port assembly in fluid communication with the first chamber; a third port assembly in fluid communication with a second chamber of the concentration container; a vent assembly including a pathway configured to a provide a flow of air between the first chamber and the second chamber; a fourth port assembly in fluid communication with a third chamber of the concentration container; and a filter separating the third chamber and the second chamber.

In Example 11, the subject matter of Example 10 optionally includes, wherein the first port assembly and the third port assembly each include a vented cap and the second port assembly and the fourth port assembly each include a non-vented cap.

In Example 12, the subject matter of Examples 10–11 optionally includes, wherein the filter separating the third chamber and the second chamber is configured to retain desiccating beads placed within the second chamber adjacent the filter.

In Example 13, the subject matter of Examples 10–12 optionally includes, wherein the vent assembly includes a filter configured to capture cells but permit the flow of air therethrough.

In Example 14, the subject matter of Example 13 optionally includes, wherein the filter is positioned in the second chamber at an opening to the pathway, wherein the opening is proud of a bottom surface of the second chamber.

In Example 15, the subject matter of Examples 13–14 optionally includes, wherein the plurality of pores are between approximately 1.5 microns and 4.5 microns in diameter.

In Example 16, the subject matter of Examples 10–15 optionally includes, wherein the vent assembly including the pathway bypasses and is not in direct fluid communication with the third chamber.

Example 17 is a method of processing a biological material, optionally comprising: introducing the biological material including a whole blood through a first port assembly into a first chamber of a separation container of a device having an assembly that includes, the separation container and a concentration container; centrifuging the device to separate the whole blood into fractions; withdrawing a platelet poor plasma of the fractions through the first port assembly from the first chamber; withdrawing a platelet rich plasma of the fractions through a second port assembly from between buoy members in the first chamber; introducing with a third port assembly the platelet rich plasma into a second chamber of the concentration container; centrifuging the device to concentrate the platelet rich plasma; and withdrawing the platelet rich plasma once concentrated from a third chamber of the concentration container through a fourth port assembly.

In Example 18, the subject matter of Example 17 optionally includes, providing for air displacement between the first chamber and the second chamber through a vent pathway extending between the first chamber and the second chamber.

In Example 19, the subject matter of Example 18 optionally includes, a filter positioned in the vent pathway and configured to capture cells but permit the air displacement, wherein the vent pathway bypasses the third chamber.

In Example 20, the subject matter of Examples 18–19 optionally includes, wherein the vent pathway allows for airflow between the first chamber and the second chamber during: the introducing whole blood, the withdrawing the platelet poor plasma, the withdrawing the platelet rich plasma, the introducing with the third port assembly the platelet rich plasma into the second chamber and the withdrawing the concentrate of the platelet rich plasma.

Example 21 is at least one machine-readable medium including instructions that, when executed by processing circuitry, cause the processing circuitry to perform operations to implement of any of Examples 1–20.

Example 22 is an apparatus comprising means to implement of any of Examples 1–20.

Example 23 is a system to implement of any of Examples 1–20.

Example 24 is a method to implement of any of Examples 1–20.

Example 25 can include or use, or can optionally be combined with any portion or combination of any portions of any one or more of Examples 1 through 24 to include or use, subject matter that can include means for performing any one or more of the functions of Examples 1-20.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected examples and not all possible examples or implementations, and these drawings are not intended to limit the scope of the present disclosure.

FIG. 1A a perspective view of a device to separate and concentrate a component of a whole material, the device including an assembly of a concentration container and separation container, according to an example of the present application.

FIG. 1B is an exploded view of the device of FIG. 1A.

FIG. 2 is a schematic view of internal components of separation container including a first chamber and a buoy system, according to an example of the present application.

FIG. 3 is a first cross-sectional view of the concentration container and a portion of the separation container showing various port assemblies communicating therewith, according to an example of the present application.

FIG. 4 is a second cross-sectional view of the concentration container showing a vent assembly having a pathway between the concentration container and the separation container, according to an example of the present application.

FIG. 5 shows a flow diagram of a method of processing a biological material with a device have an assembly of a separation container and a concentration container according to an example of the present application.

FIGS. 6-10 schematically illustrate various flow paths of air through and in or out of the device during introducing whole blood, withdrawing the platelet poor plasma, withdrawing the platelet rich plasma, introducing with the third port assembly the platelet rich plasma into the second chamber and withdrawing the concentrate of the platelet rich plasma according to examples of the present application.

### DETAILED DESCRIPTION

The present examples will now be described more fully with reference to the accompanying drawings.

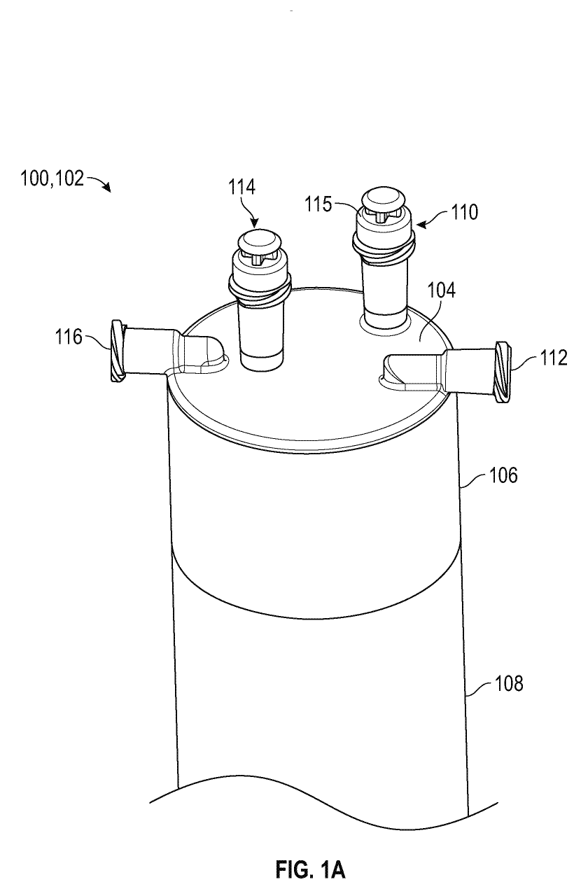

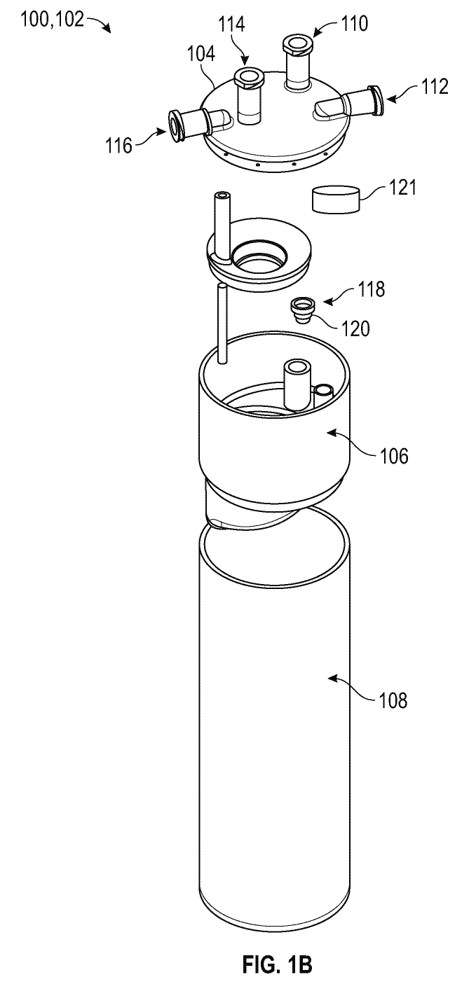

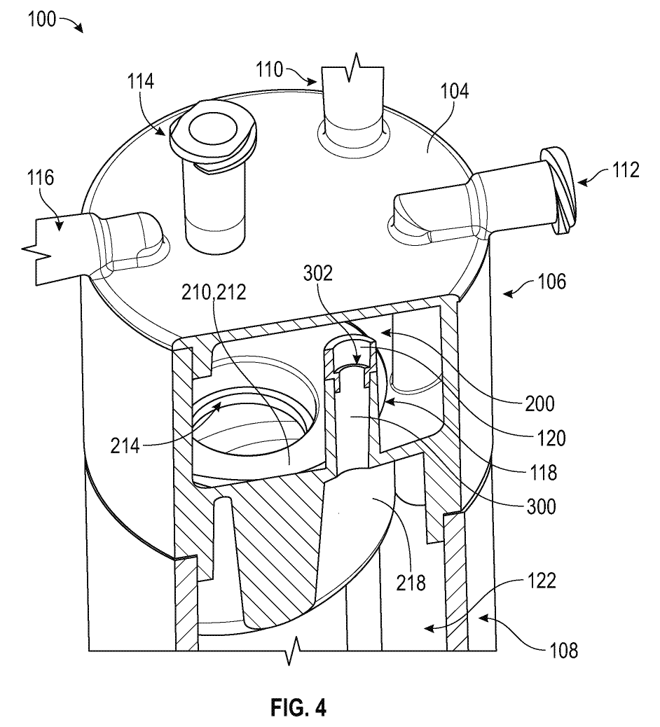

FIGS. 1A and 1B show an example of a device 100 that is an assembly 102 of a lid 104, a concentration container 106 and a separation container 108. The lid 104 is coupled to the concentration container 106. The concentration container 106 is coupled to the separation container 108. Although the lid 104, the separation container 108 and the concentration container 106 are shown as separate parts that are coupled together in FIGS. 1A and 1B, according to other examples one or more of these components may be integrated together. The device 100 additionally includes a first port assembly 110, a second port assembly 112, a third port assembly 114 and a fourth port assembly 116. As shown in FIG. 1B, the device 100 can include a vent assembly 118 including a filter 120 and a pathway (not shown in FIGS. 1A and 1B but illustrated subsequently in reference to FIG. 4). The device 100 can additionally include a screen or filter 121 in the concentration container 106 as shown in FIG. 1B.

The concentration container 106 is positioned between and couples to both the lid 104 and separation container 108. As an example, the concentration container 106 can then be fixedly connected, such as via heat welding, friction welding, adhesives, or other materials to permanently fix to the separation container 108 during fabrication thereby forming the assembly 102. Similar or different fabrication methods can be used to fix the lid 104 to the concentration container 106. Once the separation container 108, the lid 104 and the concentration container 106 are connected. Thus, they can generally define a single integrated device 100 or system. This device 100 can generally define a single outer dimension (e.g., shared diameter) along an entire length of the device 100. However, according to other examples the concentration container 106 can differ in dimension from the separation container 108.

The first port assembly 110, the second port assembly 112, the third port assembly 114 and the fourth port assembly 116 provide fluid communication paths and can pass through and in some cases can be integrated with or otherwise have portions formed by the lid 104. The first port assembly 110, the second port assembly 112, the third port assembly 114 and the fourth port assembly 116 can be at least partially formed by the lid 104. However, other examples contemplate one or more of the first port assembly 110, the second port assembly 112, the third port assembly 114 and the fourth port assembly 116 may not be formed at least partially by the lid 104 but may be formed by the sidewall(s) of the concentration container 106, for example.

As is further described herein, the first port assembly 110 and second port assembly 112 communicate with a first chamber in the separation container 108 where a buoy system is located to assist with separation. The third port assembly 114 communicates with a second chamber in the concentration container 106, while the fourth port assembly 116 communicates with a third chamber also in the concentration container 106. Referring to FIG. 1A, the first port assembly 110 and the third port assembly 114 each include a vented cap 115 and the second port assembly 112 and the fourth port assembly 116 each include a non-vented cap (not specifically shown), such as a Luer Lok® cap for the ports.

As further described herein, FIG. 1B shows the vent assembly 118, which includes a filter 120 and an associated pathway (shown later in FIG. 4). The vent assembly 118 provides direct air flow communication between the first chamber of the separation container 108 and the second chamber of the concentration container 106. The filter 120 of the vent assembly 118 is positioned within the second chamber of the concentration container 106.

The concentration container 106 also contains a screen or filter 121 as shown in FIG. 1B. This filter 121 separates the second and third chambers of the concentration container 106 and is designed to retain desiccating beads in the second chamber while allowing concentrated material to pass through to the third chamber.

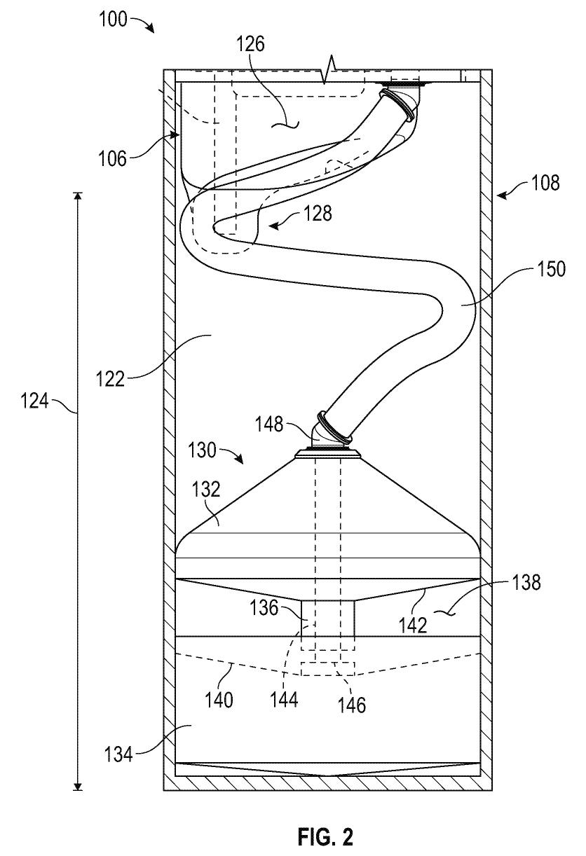

FIG. 2 shows a portion of the device 100 and is a highly schematic view of the separation container 108 and a lower portion of the concentration container 106. The separation container 108 can include a first chamber 122 configured to contain a volume of whole material that can be first separated, via centrifugation, as discussed further herein. After centrifugation, a selected fraction of the separated whole material can be moved (e.g. drawn or expressed) into the concentration container 106 for concentration and removal from the device 100.

The device 100 can generally include a selected dimension including a single or substantially uniform outer dimension, which can include an outer diameter if the device 100 is cylindrical. It is understood that the device 100 however need not be a cylinder in all examples. The device 100, particularly, the separation container 108 with the first chamber 122 can also include a height 124 (in addition to diameter or other volume dimension) that is sufficient to allow for 60mL of anticoagulated whole blood to be processed by the device 100. As illustrated in FIG. 2, a portion of the concentration container 106, including a third chamber 126 with a collection well 128, can extend into the separation container 108.

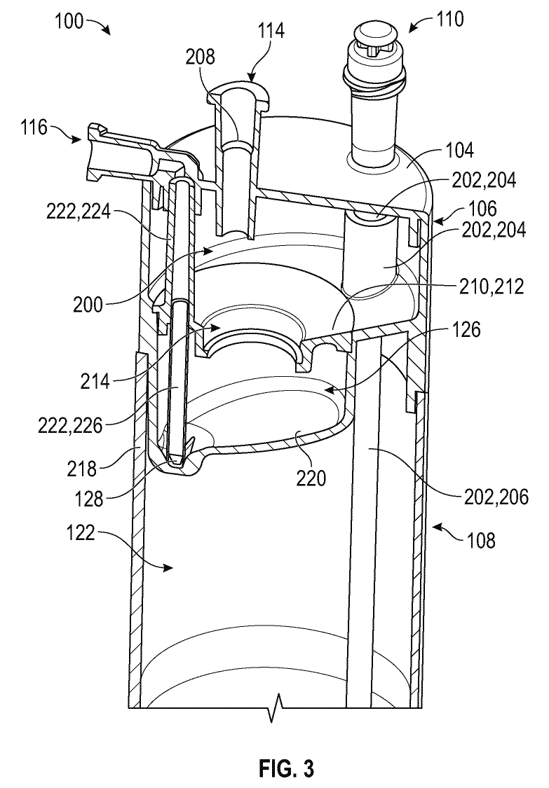

The separation container 108 can be initially filled through the first port assembly 110 (FIGS. 1A and 1B) that can include a tube (not shown in FIG. 2 but shown subsequently in FIG. 3) that passes from or through the concentration container 106 and allows whole material to be placed into the separation container 108. Once whole material is positioned in the first chamber 122 of the separation container 108, the device 100 including the whole material can be centrifuged (e.g., at 3200 RPM for about 15 minutes) or otherwise moved to apply a force to the device 100 and any materials and devices placed therein.

The separation container 108 can also include and/or contain a buoy system 130 that can include a first buoy member 132, a second buoy member 134, and a third buoy member 136. Generally, the third buoy member 136 can be a connection member that connects the first buoy member 132 and the second buoy member 134. The buoy system 130 can include a selected buoy system, such as the buoy system generally used in the GPS® II or GPS® III gravity platelet separation system sold by Zimmer Biomet, Inc. have a place of business in Warsaw, Ind. Buoy systems are disclosed in U.S. Pat. Nos. 7,179,391; 7,374,678; 7,780,860; 7,914,689; 7,954,646; 7,832,566; 10,183,042; 8,567,609; 7,845,499; 8,062,534; 9,114,334 7,992,725; 7,806,276; 8,596,470; 8,328,024; 9,649,579; 9,138,664; 8,518,272, all incorporated herein by reference in their entirety.

As an example, the buoy system 130 can be configured to have a selected density as desired such as those of the in the GPS® II or GPS® III gravity platelet separation system. Further density ranges are contemplated and include a density of about 1.05 grams per cubic centimetre (g/cm³) to about 1.08 g/cm³, including about 1.053 g/cm³ to about 1.083 g/cm³. Each of the first, second and third buoy members 132, 134 and 136 of the buoy system 130 can have a different selected density. Thus, the first buoy member 132 can have a density of about 0.93 g/cm³ to about 0.955 g/cm³ and the second buoy member 134 can have a density of about 1.075 g/cm³ to about 1.095 g/cm³. The selected density of the buoy system 130 can be selected so that it is positioned within separated whole blood to allow for a selected separation of neutrophils, basophils, and monocytes in a region, also referred to as a buoy separation region or volume, between the first buoy member 132 and the second buoy member 134. The neutrophils, basophils, and monocytes may be included in the buffy coat, but may have a density slightly different than a complete portion or selected portions of the buffy coat. Accordingly, the density of the buoy system can be selected to selectively position the buoy system, including the buoy separation volume 138 that is part of the first chamber 122 and that is defined between the first buoy member 132 and the second buoy member 134.

The neutrophils, basophils, and monocytes can include a selected protein that can be useful in treating inflammation and pain. Selected inflammation can include arthritis or other joint inflammation diseases or injuries. Selected proteins can include, but are not limited to platelet growth factors (e.g. EGF, IGF-I, IGF-BI, PDGF-AB, PDGF-BB, VEGF), protein interleukin (e.g. IL-Ia, IL-4, IL-18, and Ir1L), and cytokines (e.g. sTNF-RI and sTNF-RII) that can be released and concentrated as further discussed herein to form an Autologous Protein Solution (APS) (sometimes referred to herein simply as concentrated platelet rich plasma).

The buoy system 130 can further include a desired geometry. As an example, the second buoy member 134 can include a concave collection face 140 and the first buoy member 132 can include a convex collection face 142. According to some examples, the collection faces 140, 142 can be complementary in shape such that the two can mate so that substantially little area or volume is between the two collection faces 140, 142. According to various embodiments, the first buoy member 132 can move relative to the second buoy member 134 at various times. For example, as discussed further herein, when the volume within the buoy collection volume 138 is emptied, the first buoy member 132 can move relative to the second buoy member 134 to allow for change in volume when moving or removing a selected fraction from the collection volume 138. It will also be understood, as also discussed herein, that the first buoy member 132 can be fixed relative to the second buoy member 134 such that the collection volume 138 is fixed.

The selected fraction can be removed from the collection volume 138 through the third buoy member 136 that can define a removal passage 144 connected with collection face passages 146. A connection elbow 148 can interconnect with the removal passage 144. The connection can be sufficient to allow a vacuum (such as formed by a withdrawal syringe) to be formed through the second port assembly 112 including through of a collection tube 150, the connection elbow 148, the removal passage 144, the collection face passages 146 and other pathway of the second port assembly 112 not shown in FIG. 2. Collectively, the connection elbow 148, the removal passage 144, and the collection face passages 146 can be part of the second port assembly 112. The collection tube 150 that is also part of the second port assembly 112 (FIGS. 1A and 1B) can interconnect the connection elbow 148 with a withdrawal elbow (shown but not specifically number) that extends from a wall that can be a bottom wall of the concentration container 106.

Turning to FIG. 3, portions of the device 100 are illustrated in a first cross-section including the lid 104, the concentration container 106, the separation container 108, the first port assembly 110, the third port assembly 114 and the fourth port assembly 116, the first chamber 122 and the third chamber 126. The concentration container 106 additionally includes a second chamber 200. The first port assembly 110 can include a pathway 202 formed by portions 204 and a lower tube 206. Similarly, the third port assembly 114 includes a pathway 208 for fluid communication with the second chamber 200. The second chamber 200 can be separated from the third chamber 126 by one or more walls 210 including those formed by a platform portion 212 having a central passage 214 and the screen or filter 121 (not shown in FIG. 3 but previously shown in FIG. 1B). The third chamber 126 can be positioned below and in fluid communication with the second chamber 200 via the central passage 214 and the screen or filter 121 (not shown but illustrated previously in FIG. 1B). The third chamber 126 can include sidewalls 218, a ramped bottom wall 220, and the collection well 128 (also previously shown in FIG. 2). The fourth port assembly 116 can include a pathway 222 formed by portions 224 and a collection tube 226.

The first chamber 122 is located in and formed at least partially by the separation container 108 and connects to the first port assembly 110 through the pathway 202 formed by the portions 204 (portions of a housing of the concentration container 106 and lid 104) and the lower tube 206. This configuration allows for introduction and removal of whole and one or more fractionated materials from the separation container 108.

The concentration container 106 contains both the second chamber 200 and the third chamber 126. The third port assembly 114 includes the pathway 208 that provides fluid communication with the second chamber 200. The second chamber 200 is separated from the third chamber 126 by walls 210 including the platform portion 212 with the central passage 214. As is further discussed subsequently, the screen or filter 121 (shown in previous FIG. 1B) is positioned at this interface with the central passage 214 to retain desiccating beads while allowing concentrated material to pass through to the third chamber 126. The third chamber 126 features specific geometry including the sidewalls 218 and the ramped bottom wall 220 that leads to the collection well 128. This design facilitates collection of the concentrated material via the fourth port assembly 116. The fourth port assembly 116 provides access to the third chamber 126 through the pathway 222 formed by the portions 224 (interconnected portions of the lid 104 and the platform portion 212) and the collection tube 226. The collection tube 226 that extends down to the collection well 128 to allow withdrawal of the concentrated material.

FIG. 4 shows a second cross-section of the device 100. The second cross-section of FIG. 4 differs from the first cross-section of FIG. 3 in location. Thus, FIG. 4 shows many of the components of features of FIG. 3 and additionally illustrates the vent assembly 118 including the filter 120 and a pathway 300. The pathway 300 provides direct fluid communication between the second chamber 200 and the first chamber 122. FIG. 4 additionally illustrates at least parts of the lid 104, the concentration container 106, the separation container 108, the first port assembly 110, the second port assembly 112, the third port assembly 114, the fourth port assembly 116, the first chamber 122, the second chamber 200, the one or more walls 210 including those formed by the platform portion 212 having the central passage 214.

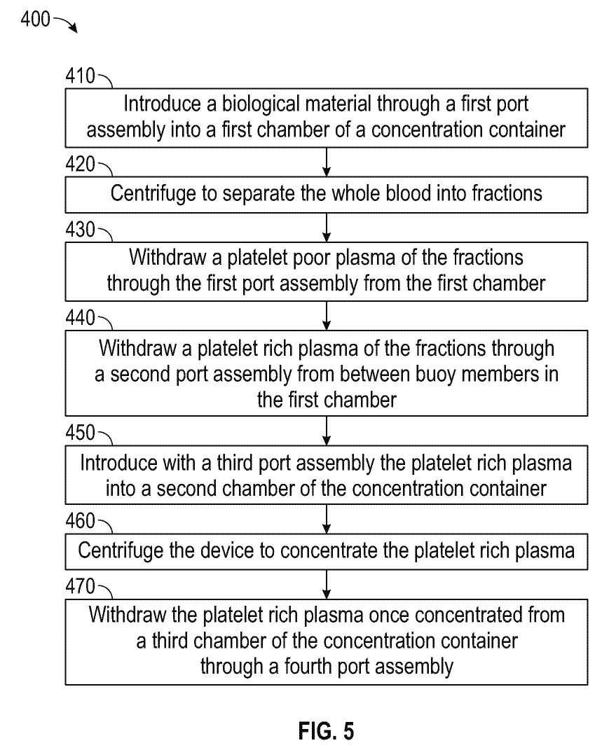

Referring now to FIGS. 3 and 4, the concentration container 106 can be separate from the separation container 108 such that biological materials placed in concentration container 106 do not enter the separation container 108 and vice versa. However, due to the vent assembly 118 including the filter 120 and the pathway 300 as shown in FIG. 4, air can freely and directly pass between the concentration container 106 and the separation container 108. Thus, use of the vent assembly 118 allows for movement of air displaced during the filling and withdrawing methodology discussed and shown subsequently in FIGS. 5-10. The concentration container 106 can be fitted to any end of the device 100. Thus, the concentration container 106 need not be fitted at a “top” of the device 100 as shown or near where the lightest fraction would separate. Thus, according to some examples, the concentration container 106 can be positioned at a “bottom” of the device 100 below the buoy system shown previously.

Once the selected fraction (e.g., a platelet rich plasma) is withdrawn from the buoy separation system and the first chamber 122 of the separation container 108 as discussed and shown in FIG. 2 through the second port assembly 112, it can be injected into the concentration container 106, and particularly into the second chamber 200, through the third port assembly 114. Additionally, another fraction of the whole material (e.g., platelet poor plasma) can be removed/withdrawn from the first chamber 122 of the separation container 108 using the first port assembly 110 including the pathway 202 and the lower tube 206 that is in fluid communication therewith.

Once injected into the second chamber 200 of the concentration container 106, the selected fraction (e.g., platelet rich plasma) can pass along the one or more walls 210 including those formed by the platform portion 212 to adjacent the central passage 214. Although not illustrated in FIGS. 3 and 4 the screen or filter 121 (shown in FIG. 1B) can be positioned in the central passage 214 along with desiccating beads or other material (not shown). The screen or filter 121 can be held in place by tight fit, ridge or other feature(s) of the central passage 214 of the platform portion 212. The selected fraction can then be positioned within the second chamber 200 and can be mixed with the desiccating beads held atop the filter 121 (FIG. 1B).

The desiccating beads can be a selected bead such as a bead formed of a polyacrylamide. The polyacrylamide material can interact with the neutrophils, basophils, and monocytes in the selected fraction to release the selected proteins which can include, but are not limited to platelet growth factors (e.g. EGF, IGF-I, IGF-BI, PDGF-AB, PDGF-BB, VEGF), protein interleukin (e.g. IL-1a, IL-4, IL-18, and Ir1L), and cytokines (e.g. sTNF-RI and sTNF-RII). It will be understood that other selected materials can also be released and that the polyacrylamide can desiccate or remove water or moisture from the fraction withdrawn from the buoy system of FIG. 2 and can also bind selected materials and proteins that are not selected for concentration within the concentration container 106. The desiccating beads can interact with the selected fraction, as discussed further herein, including via shaking or centrifugation. The dissecting beads can be maintained within the second chamber 200 by the filter 121 (FIG. 1B).

After a selected time with interaction with the desiccating beads, the device 100 can again be positioned in a centrifuge to force a separation of the now concentrated material from the desiccating beads by passing through the filter 121 (FIG. 1B) to the third chamber 126 that is below or on an opposite side of the filter 121 (FIG. 1B). The third chamber 126 can have the sidewalls 218 forming a basket type configuration below the second chamber 200 and extending into the separation container 108 as previously discussed. The concentrated material can then collect by passing along and down the ramped bottom wall 220 to the collection well 128 shown in FIG. 3. Again, referring to FIG. 3, the fourth port assembly 116 can form the pathway 222 via the collection tube 226, which can extend into the collection well 128. The collection tube 226 can connect with various of the portions 224 including interconnected portions formed by the lid 104 and the platform portion 212. A withdrawal syringe can be interconnected with the fourth port assembly 116 to withdraw the concentrated material from the collection well 128 through the pathway 222.

The device 100 can be dimensioned to operate with a selected centrifuge system such as the DRUCKER 755VES and/or the Thermo International Equipment Company IEC 7426, 7427, or 7428 centrifuge systems and the centrifuge system commonly used with the GPS® II or GPS® III gravitation platelet separation systems. The first round of centrifugation for separation can be at 3200 RPM for about 15 minutes. The second round of centrifugation for concentration can be at 3200 RPM for about 2 minutes.

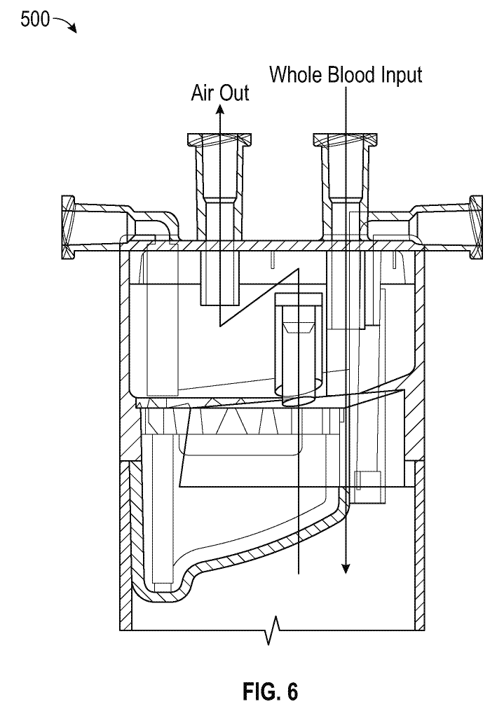

As shown in FIG. 4, the vent assembly 118, and particularly, the pathway 300 can bypass the third chamber 126 (i.e. is offset therefrom so as to not be in direct fluid communication therewith). Thus, the pathway 300 can pass through the one or more walls 210 and/or sidewalls 218. As shown in FIG. 4, the vent assembly 118 is located to an exterior side of the sidewalls 218 and does not pass therethrough. However, arrangements where the vent assembly 118 would pass through the third chamber 126 are also contemplated. Additionally, the vent assembly 118, and in particular, the filter 120 and an opening 302 to the pathway 300 can be elevated so as to be proud of the one or more walls 210 including those formed by the platform portion 212. This configuration ensures the opening 302 will be located above a surface of the selected fraction when the selected fraction is loaded into the second chamber 200. The filter 120 can be located at the opening 302 and can extend into the pathway 300. The vent assembly 118 can be offset to a side from the first port assembly 110, the second port assembly 112, the third port assembly 114, the fourth port assembly 116, the platform portion 212 and the central passage 214. The vent assembly 118 can allow venting of the separation container 108 and the concentration container 106 during entry and removal of materials by allowing adjustment for pressure and volume changes when introducing the material (whole or fractionated) into the device 100 and withdrawing at least portions of the whole material from the device 100 as further illustrated in FIGS. 6-10.

The filter 120 can be formed of polymeric material (e.g., polyethylene) and can have a plurality of pores therethrough. The number and spacing of the plurality of pores can vary. The plurality of pores can be between approximately 1.5 microns and 4.5 microns in diameter, which is a size sufficient to capture cells but permit the flow of air therethrough.

FIG. 5 shows flow chart of a method 400 of processing a biological material that optionally includes introducing 410 the biological material including a whole blood through a first port assembly into a first chamber of a device having an integrated assembly of a separation container and a concentration container. The method 400 can include centrifuging 420 the integrated device to separate the whole blood into fractions and withdrawing 430 a platelet poor plasma of the fractions through the first port assembly from the first chamber. The method 400 withdrawing 440 a platelet rich plasma of the fractions through a second port assembly from between buoy members in the first chamber. The method 400 includes introducing 450 with a third port assembly the platelet rich plasma into a second chamber of the concentration container through a third port. The method 400 can include centrifuging 460 the integrated device to concentrate the platelet rich plasma and withdrawing 470 the platelet rich plasma once concentrated from a third chamber of the concentration container through a fourth port assembly.

The method 400 can optionally further include providing for air displacement between the first chamber and the second chamber through a vent pathway extending between the first chamber and the second chamber. The method can further include a filter positioned in the vent pathway and configured to capture cells but permit the air displacement, wherein the vent pathway bypasses the third chamber. The vent pathway can allow for airflow between the first chamber and the second chamber during: the introducing whole blood, the withdrawing the platelet poor plasma, the withdrawing the platelet rich plasma, the introducing with the third port assembly the platelet rich plasma into the second chamber and the withdrawing the concentrate of the platelet rich plasma.

FIGS. 6-10 schematically illustrate various flow paths for airflow through and in or out of the device during introducing whole blood, withdrawing the platelet poor plasma, withdrawing the platelet rich plasma, introducing with the third port assembly the platelet rich plasma into the second chamber and withdrawing the concentrate of the platelet rich plasma according to examples of the present application.

FIG. 6 illustrates a step 500 where the vent pathway is used for airflow passage during whole blood input into the first chamber. As shown, the air is displaced from the first chamber of the separation container through the vent pathway into the second chamber of the concentration chamber and out of the device to ambient through the third port assembly.

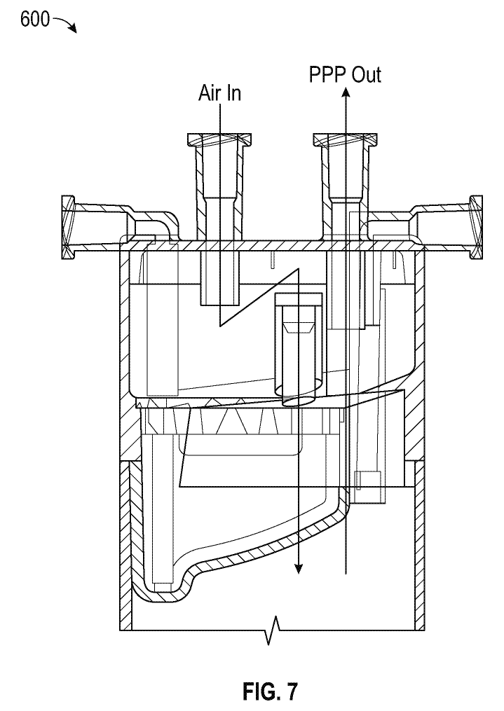

FIG. 7 illustrates a step 600 where the vent pathway is used for airflow passage during withdrawal of platelet poor plasma from the first chamber of the separation container using the first port assembly. The air is drawn in from ambient and displaced from the second chamber of the concentration chamber through the vent pathway into the first chamber of the separation container.

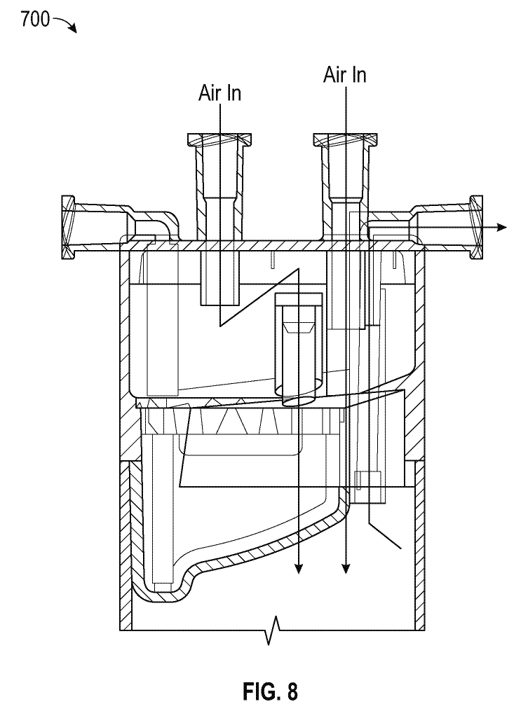

FIG. 8 illustrates a step 700 where the vent pathway is used for airflow passage during withdrawal of cell solution (e.g., platelet rich plasma) from the first chamber of the separation container using the second port assembly. In FIG. 8, the air is drawn in from ambient and displaced from the second chamber of the concentration container through the vent pathway into the first chamber of the separation container. Additionally, air can be drawn in from ambient to the first chamber of the separation container using the first port assembly.

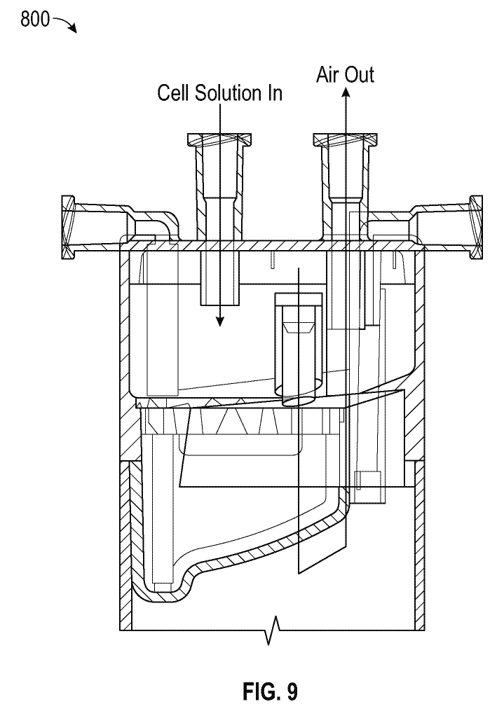

FIG. 9 illustrates a step 800 where the vent pathway is used for airflow passage during introducing the platelet rich plasma into the second chamber using the third port assembly. As shown in FIG. 9, the air is displaced from the second chamber of the concentration container through the vent pathway into the first chamber of the separation container and out of the device to ambient through the first port assembly.

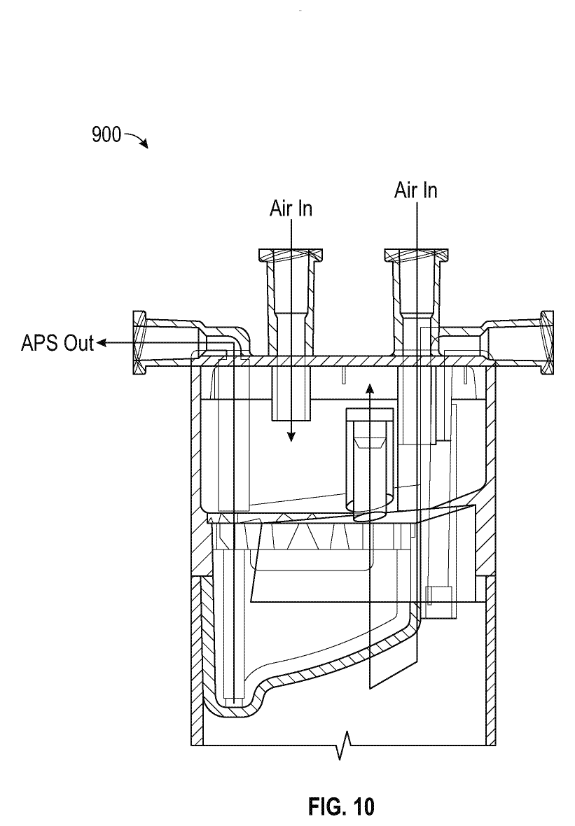

FIG. 10 illustrates a step 900 where the vent pathway is used for airflow passage during withdrawal of the concentrate of the platelet rich plasma from the third chamber using the fourth port assembly. As shown in FIG. 10, the air is drawn in from ambient via the first port assembly and the third port assembly and displaced from the third chamber of the concentrate container using the fourth port assembly. Additionally, air can flow from the first chamber of the separation container to the second chamber (and on to the third chamber in fluid communication with the second chamber) of the concentration container using the vent pathway as indicated.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled. In the event of inconsistent usages between this document and any documents incorporated herein by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example embodiments. Moreover, in the following claims, the terms “first,” “second,” and “third,” etc. are used merely as labels, and are not intended to impose numerical requirements on their objects

The terminology used herein is for the purpose of describing particular example embodiments only and is not intended to be limiting. As used herein, the singular forms "a," "an," and "the" may be intended to include the plural forms as well, unless the context clearly indicates otherwise. The terms "comprises," "comprising," "including," and "having," are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A device to separate and concentrate a component of a whole material, comprising:
a separation container forming a first portion of the device and a concentration container forming a second portion of the device;
a buoy system positioned within a first chamber of the separation container, wherein the buoy system configured to assist in a separation of the whole material;
a first port assembly and a second port assembly in fluid communication with the first chamber;
a third port assembly in fluid communication with the concentration container; and
a vent assembly including a pathway configured to a provide a flow of air between the first chamber and a second chamber of the concentration container.

2. The device of claim 1, further comprising a fourth port assembly in fluid communication with a third chamber of the concentration container.

3. The device of claim 2, wherein the first port assembly and the third port assembly each include a vented cap and the second port assembly and the fourth port assembly each include a non-vented cap.

4. The device of claim 3, further comprising a filter positioned between and separating the third chamber from the second chamber and configured to support a desiccant placed within the second chamber adjacent the filter.

5. The device of claim 1, wherein the vent assembly includes a filter configured to capture cells but permit the flow of air therethrough.

6. The device of claim 5, wherein the filter is positioned in the second chamber at an opening to the pathway, wherein the opening is proud of a bottom surface of the second chamber.

7. The device of claim 6, wherein the filter is formed of polymeric material having a plurality of pores therethrough.

8. The device of claim 7, wherein the plurality of pores are between approximately 1.5 microns and 4.5 microns in diameter.

9. The device of claim 8, wherein the vent assembly including the pathway bypasses and is not in direct fluid communication with a third chamber of the concentration container.

10. A device to separate and concentrate a component of a whole material, comprising:
a separation container forming a first portion of the device and a concentration container forming a second portion of the device;
a buoy system positioned within a first chamber of the separation container, wherein the buoy system configured to assist in a separation of the whole material;
a first port assembly and a second port assembly in fluid communication with the first chamber;
a third port assembly in fluid communication with a second chamber of the concentration container;
a vent assembly including a pathway configured to a provide a flow of air between the first chamber and the second chamber;
a fourth port assembly in fluid communication with a third chamber of the concentration container; and
a filter separating the third chamber and the second chamber.

11. The device of claim 10, wherein the first port assembly and the third port assembly each include a vented cap and the second port assembly and the fourth port assembly each include a non-vented cap.

12. The device of claim 10, wherein the filter separating the third chamber and the second chamber is configured to retain desiccating beads placed within the second chamber adjacent the filter.

13. The device of claim 10, wherein the vent assembly includes a filter configured to capture cells but permit the flow of air therethrough.

14. The device of claim 13, wherein the filter is positioned in the second chamber at an opening to the pathway, wherein the opening is proud of a bottom surface of the second chamber.

15. The device of claim 13, wherein the filter is formed of polymeric material having a plurality of pores therethrough, wherein the plurality of pores are between approximately 1.5 microns and 4.5 microns in diameter.

16. The device of claim 10, wherein the vent assembly including the pathway bypasses and is not in direct fluid communication with the third chamber.

17. A method of processing a biological material, comprising:
introducing the biological material including a whole blood through a first port assembly into a first chamber of a separation container of a device having an assembly that includes the separation container and a concentration container;
centrifuging the device to separate the whole blood into fractions;
withdrawing a platelet poor plasma of the fractions through the first port assembly from the first chamber;
withdrawing a platelet rich plasma of the fractions through a second port assembly from between buoy members in the first chamber;
introducing with a third port assembly the platelet rich plasma into a second chamber of the concentration container;
centrifuging the device to concentrate the platelet rich plasma; and
withdrawing the platelet rich plasma once concentrated from a third chamber of the concentration container through a fourth port assembly.

18. The method of claim 17, further comprising providing for air displacement between the first chamber and the second chamber through a vent pathway extending between the first chamber and the second chamber.

19. The method of claim 18, further including a filter positioned in the vent pathway and configured to capture cells but permit the air displacement, wherein the vent pathway bypasses the third chamber.

20. The method of claim 19, wherein the vent pathway allows for airflow between the first chamber and the second chamber during: the introducing whole blood, the withdrawing the platelet poor plasma, the withdrawing the platelet rich plasma, the introducing with the third port assembly the platelet rich plasma into the second chamber and the withdrawing the concentrate of the platelet rich plasma.
